(19) United States
(12) Patent Application Publication
(10) Pub. No.: US 2005/0129819 A1
(43) Pub. Date: Jun. 16, 2005

(54) Process and apparatus for preparing frozen confection

(75) Inventor: Patrick Gibson Lennon, De Pere, WI (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Good Humor-Breyers Ice Cream

(21) Appl. No.: 10/732,629

(22) Filed: Dec. 10, 2003

(51) Int. Cl. A01J 1/00

(52) U.S. Cl. 426/515

(57) ABSTRACT

A method of making a combined frozen confection, equipment for forming same. The equipment especially comprises a filling nozzle. The invention is particularly directed to combined frozen confections formed in pop ups or the like. The combined frozen confection is especially a pop up having a shape extruded down the center, preferably an intricate shape such as a star or a pineapple, which remains recognizable over the length of the pop up cylinder. A second confection, preferably one having a different color or other appearance, flows into the pop-up cylinder around the periphery of the centrally extruded frozen confection to form a frozen confection combining the extruded frozen confection design and the peripheral frozen confection identifiable by consumers as different.

### BACKGROUND OF THE INVENTION

While children enjoy frozen confections in the forms in which adults usually take them, for example, as scoops of ice cream, ice milk, frozen yogurt, sherbet, sorbet or the like, presenting a child with a frozen confection which includes an ornamental aspect such as the shape of a favorite character has special appeal.

Especially attractive are products combining consumer-identifiably different frozen confections, e.g., different colors and/or flavors, to form a combined frozen confection in the form of one or several characters or other designs. In preferred products, the extruded design is visibly distinguishable from the rest of the frozen confection. Unfortunately, forming a design using combined frozen confections poses special technical challenges.

Among the frozen confection product forms especially attractive to children are the “pop up,” wherein the frozen confection is confined within an open-ended cylinder and rests on a round platform. Access to the frozen treat is provided by exerting an upward force on the frozen platform to move the frozen confection above the open end of the cylinder. The platform is often provided with a downwardly extending stick or other means for assisting the consumer in forcing the platform upwardly.

Binley U.S. Pat. No. 5,556,653 discloses coextrusion of a chocolate or other couverture with an ice confection.

White et al. U.S. Pat. Nos. 5,720,175 and 5,582,856 disclose systems for making a frozen confection having differently flavored or colored sections. The products are molded and several arrangements are suggested for making the differently colored/flavored sections, e.g., removing a portion of the product after molding and then re-molding with the different colored/flavored section replacing the removed section, or spraying a first colored/flavored section onto the mold and then adding a second colored section.

Crowder U.S. Pat. No. 3,971,853 discloses a frozen confection comprising a plurality of ingredients of individual colors. A nozzle having a plurality of inlet conduits and one discharge opening for forming the frozen confection is disclosed.

Tindall U.S. Pat. No. 4,515,190 is directed to an ice cream can filling machine with nozzles for a varigating liquid such as a syrup.

There is still a need for an effective way to manufacture a combined frozen confection with good definition.

### SUMMARY OF THE INVENTION

The present invention is directed to a method of making a combined frozen confection, and to equipment for forming same. The equipment especially comprises a filling nozzle. The invention is particularly directed to combined frozen confections formed in pop ups or the like. The combined frozen confection is especially a pop up having a shape extruded down the center, preferably an intricate shape such as a star or a pineapple, which remains recognizable over the length of the pop up cylinder. A second confection, preferably one having a different color or other appearance, flows into the pop-up cylinder around the periphery of the centrally extruded frozen confection to form a frozen confection combining the extruded frozen confection design and the peripheral frozen confection identifiable by consumers as different.

The method and the nozzle of the invention are capable of producing an extruded shape in very good detail, in contrast with at least one other product presently available in the market, wherein the level of detail of the extruded shape is more modest.

The nozzle of the invention has an internal shape corresponding to the desired shape of the extruded central shaped frozen confection. Preferably the nozzle includes a very thin wall and the outside of the wall defines the shape for the peripheral frozen confection flow. The nozzle can be stopped and started for intermittent filling while maintaining shape control. This allows the nozzle to be easily mounted on cup and tube filling equipment. Preferably the nozzle is 1.5 inches or longer. Longer nozzle lengths are believed to result in improved shape definition.

The method and nozzle of the invention may be used in many different types of frozen confection products, e.g., to extrude shapes into a ½ gallon carton, a cone, a pop up or onto a stick frozen confection, e.g., a Popsicle brand ice pop.

For a more complete understanding of the above and other features and advantages of the invention, reference should be made to the following detailed description of preferred embodiments and to the accompanying drawings.

### BRIEF DESCRIPTION OF THE DRAWINGS

FIG. 1 is a perspective view of a mandrel through which frozen confection is fed to a nozzle.

FIG. 2 is a partial cross section along the lines 2-2 of FIG. 1.

FIG. 3 is a partial cross section along the lines 3-3 of FIG. 1.

FIG. 4 is a partial cross section of a shaped nozzle which can be accommodated within the mandrel of FIG. 1.

FIG. 5 is a partial cross section of an alternative shaped nozzle which can be accommodated within the mandrel of FIG. 1.

FIG. 6 is a perspective view of a nozzle cap which can be used in the invention.

FIG. 7 is a cross sectional view of the cap of FIG. 6.

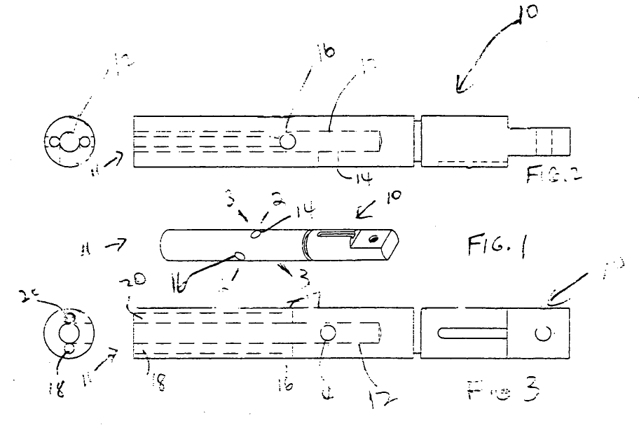

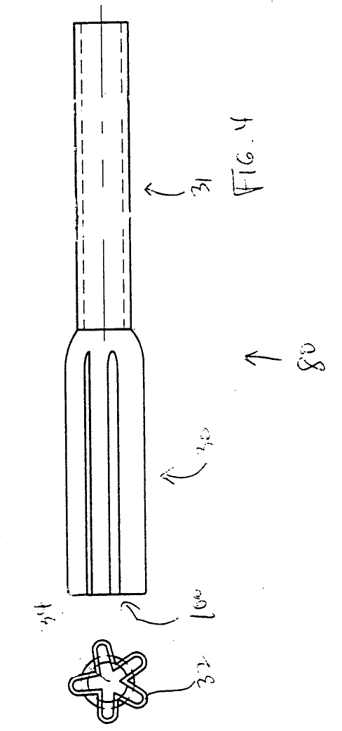

### DETAILED DESCRIPTION OF THE INVENTION

A stainless steel mandrel 10 may be employed in the invention. Mandrel 10 includes a central channel 12 which opens at one end 11. Port 14 is disposed medially of the mandrel and permits fluid communication between channel 12 and the outside of the mandrel. In addition to central channel 12, two peripheral channels 18 and 20 are disposed within mandrel 10 on opposite sides of central channel 12. Ports 16 and 17 open from channels 18, 20 to the outside of the mandrel so that these channels also are in fluid communication with the exterior. Channels 18 and 20 open to the exterior of the mandrel at end 11.

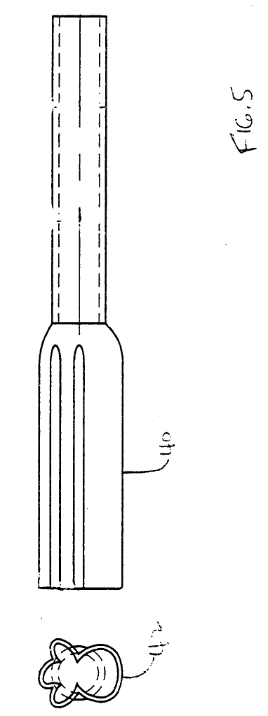

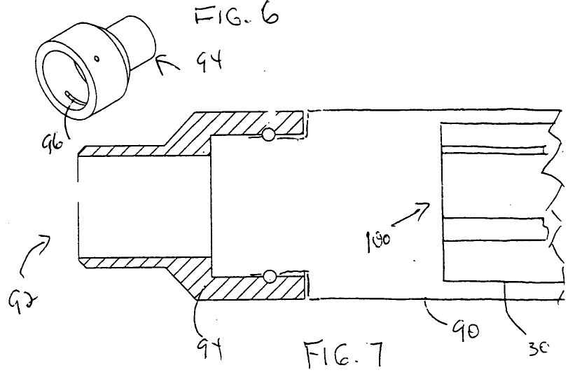

Seen in FIG. 4, is a nozzle 80 having a shaped (in cross section) portion 30 and a cylindrical (in cross section) portion 31. Nozzle shaped portion 30 has the cross sectional shape of a star. Section 31 of nozzle 80 will be inserted into the open end of mandrel 10 and an opening drilled, or otherwise formed, therein in alignment with port 14 of mandrel 10. After insertion, section 31 is substantially fully accommodated within channel 12 of mandrel 10 whereas shaped section 30 will project outwardly from the 11 end of mandrel 10. In this way, central channel 34 of nozzle 80 will be in fluid communication with port 14 of mandrel 10.

Shaped section 30 imparts to centrally extruded portions of the frozen confection a shape corresponding to the shape of the cross section of section 30, for instance, star 32. Peripheral channels 18 and 20 communicate with the exterior of nozzle 30 at end 11.

FIG. 5 shows a nozzle 40 having an alternative shape, that of a pineapple.

Mandrel 10 and the shaped section 30 of nozzle 80 which extends from one end thereof, are housed in housing 90, which may be made from stainless steel or other materials. Housing 90 includes an opening 92 which may be formed by cap 94 or other means. Cap 94 may be associated with the housing by use of screws 96 or other known means.

In operation, a first frozen confection is fed, for example by tubing, into port 14 and into section 31 of nozzle 80 which has been inserted into channel 12 of mandrel 10. First frozen confection then travels through central channel 34 of nozzle 80. First frozen confection, still within nozzle 80, traverses end 11 of mandrel 10 and enters central channel 34 of nozzle 30. First frozen confection constitutes the central extrudate.

Meanwhile, a second frozen confection, which is consumer identifiably different from the first, is fed into ports 16 and 17 of mandrel 10 and thence into peripheral channels 18 and 20. These, likewise, traverse end 11 of mandrel 10. Typically, these will not be in fluid communication with central channel 34 of nozzle 30. Rather, they emerge from end 11 to the exterior of nozzle 30 but within housing 90. They then fill in the space between the outer, thin walls of the nozzle 80 and the cylindrical wall of housing 90. The result is a central extrudate formed from the first frozen confection and a peripheral extrudate formed from the second frozen confection.

The combined extrudate is urged toward opening 92 of cap 94. It has been found desirable to leave at least 1.5 inches between the end 100 of nozzle 80 and opening 92 of cap 94. It has also been found desirable that the cross section area of opening 92 is smaller than the cross sectional area of the combined extrudate. For instance, the nozzle might be 1/2 inch in diameter. The diameter of the nozzle could, for instance, be 80% or even 60% or the inner diameter of the housing and thence of the combined extrudate cross section.

It has been found desirable to begin to extrude first the second frozen confection from the peripheral channels, 16 and 17, that is to give them a lead time, which may be for instance sufficient to provide a lead of approximately at least 2 inches in length.

Upon emerging from opening 92, the combined extrudate can be fed into the cylinder of a push up or some other frozen confection container. Since the second confection is identifiably different, e.g., a different color, the consumer can identify the design of the central extrudate as a star, pineapple or other figure. Moreover, the extended length of the nozzle is believed to permit enhanced definition of the central extrudate. In addition, the design of the mandrel/nozzle combination, permits intermittent filling by accommodating stopping and starting while maintaining shape control.

It should be understood of course that the specific forms of the invention herein illustrated and described are intended to be representative only, as certain changes may be made therein without departing from the clear teaching of the disclosure. Accordingly, reference should be made to the appended claims in determining the full scope.

1. A process for making a combined frozen confection, comprising feeding a first frozen confection into a central channel of a nozzle, and feeding a second, identifiably different frozen confection external of the nozzle whereby a combined frozen confection is formed having a first central extrudate frozen confection and a second identifiably different frozen confection.

2. The process according to claim 1 wherein said central extrudate forms a recognizable design.

3. The process according to claim 2 wherein said design is in the shape of a star or a pineapple.

4. The process according to claim 1 wherein said combined frozen confection is contained within a cylindrical wall of a push up.

5. The process according to claim 1 wherein said first frozen confection is fed into said nozzle central channel from a central channel of a mandrel.

6. The process according to claim 5 wherein said second frozen confection is fed to the exterior of said nozzle through one or more peripheral channels of said mandrel.
